(19) United States
(12) Patent Application Publication
(10) Pub. No.: US 2012/0129020 A1
(43) Pub. Date: May 24, 2012

(54) TEMPERATURE-CONTROLLED BATTERY SYSTEM II

(75) Inventors: Walter Lachenmeier, Sankt Augustin (DE); Andreas Gutsch, Luedinghausen (DE); Tim Schaefer, Niedersachswerfen (DE)

(73) Assignee: LI-TEC BATTERY GMBH, Kamenz (DE)

(21) Appl. No.: 13/145,725

(22) PCT Filed: Jan. 19, 2010
(86) PCT No.: PCT/EP2010/000288

§ 371 Date: Feb. 7, 2012

(30) Foreign Application Priority Data
Jan. 23, 2009 (DE) 10 2009 005 853.2

(51) Int. Cl. H01M 10/50

(52) U.S. Cl. 429/62; 429/120

(57) ABSTRACT

The invention relates to a battery system comprising at least one battery. According to the invention, provisions are made that said battery system comprises at least one Peltier element, which is used for cooling and/or for heating at least one battery.

Priority application 10 2009 005 853 as filed on Jan. 23, 2009 is fully incorporated by reference herein.

The invention relates to a battery system having at least one battery according to claim 1. The invention is described in the context of lithium-ion batteries. It is noted that the invention may also be applied to other batteries regardless of the chemistry of the battery, or also for rechargeable batteries.

Batteries, in particular lithium-ion batteries, are known from the prior art as environmentally friendly energy storage devices having particularly high power. As so-called “large format batteries”, these batteries are particularly useful for energy storage in modern electric and hybrid vehicles. In addition, stationary battery systems are known, for example, as emergency power supply of buildings.

As a result of charging and discharging processes, heat generation occurs in batteries, wherein said generated heat must be removed in order to prevent heat accumulation and to maintain an optimum operating temperature for the electrical efficiency of the battery. On the other hand, at low temperatures, it may be advantageous to increase the operating temperature of a battery in order to improve electrical efficiency. Electrical efficiency can be measured, e.g., by means of an efficiency factor, an electrical capacity, or a temporary power generation (power output). At the moment, primarily, heaters in combination with compression cooling systems, are used for the temperature control of batteries. Therein, a disadvantage is the increased space requirement. In addition, compression cooling systems (“Kompressionskälteanlagen”) have a poor environmental or ecological balance, respectively. The operation of a battery in the range of its optimum operating temperature also extends the lifespan of the battery.

One objective of the invention is to provide means to extend the lifespan of batteries.

This objective is achieved by a battery system with the features of claim 1. The features of the dependent claims relate to advantageous and preferred embodiments. Preferred uses of the battery system according to the invention are the subject-matter of the dependent claims.

According to the invention, a battery system is provided, including at least one battery, characterized in that at least one Peltier element is included, which is used for the cooling and/or for the warming of at least one battery. Preferably, said Peltier element is used for the cooling of at least one battery.

Due to the cooling and/or the warming of the battery by means of said Peltier element, the lifespan of a battery, or, respectively, of a plurality of batteries, can be extended.

As is generally known from the prior art, a battery can be formed from a single cell or from a plurality of, e.g., stacked cells. Furthermore, according to the invention, a set of batteries can also be provided. The battery also comprises an electrolyte. This electrolyte may include lithium-ions.

A Peltier element according to the present invention refers to a thermoelectric converter, which, based on the Peltier effect, generates a useable temperature difference based on an electrical current. The Peltier effect can generally be described as follows: When bringing the two ends of a metal or of a semiconductor in contact with another metal or semiconductor, and when applying a direct current (DC), one contact point warms up, while the other contact point cools down. Thereby, a temperature difference is generated between the two points, which, preferably, can be used for cooling or, when switching the electrical polarity, also for warming. Peltier elements are available in the market as ready-to-use components with different specifications. When operating for cooling, said Peltier elements comprise, for example, one cold side or area and one warm side or area. The cold side can be used for cooling and, when switching the polarity, may also be used for warming. Common Peltier elements are typically based on semiconductors (p- and/or n-conductor).

Essential advantages of Peltier elements include their small structural size and the fact that moving parts and components are avoided. In addition, Peltier elements can be operated without the use of cooling fluids, which are needed, for example, for cooling systems and, in particular, for compression cooling systems. Therefore, Peltier elements have, among others, a good environmental balance. According to the present invention, the above described disadvantages associated with the prior art are avoided/minimized. Furthermore, Peltier elements are relatively inexpensive, especially, compared to heaters and compression cooling systems as presently used.

Preferably, a plurality of Peltier elements is included, which Peltier elements, in particular, may also be of different type or, respectively, of different design.

According to a preferred embodiment, provisions are made that the Peltier element is used or may be used, selectively, either for cooling and/or for heating of the battery by switching the electrical polarity. By means of a selective switching of the current, as preferred, the Peltier element allows for both cooling and heating of the battery. Thereby, a comprehensive temperature control (thermostatisation) of the battery is possible in order to operate the battery within its range of optimum operating temperature. Preferably, the battery system includes a corresponding device for reversing or switching the current.

According to a preferred embodiment, provisions are made that the Peltier element is exposed to convection. By means of this convection, heat transfer occurs between the Peltier element and a gas that flows by or that flows towards the Peltier element, wherein the gas is preferably air. This air may, for example, be the head wind of a motor vehicle. The Peltier element may be exposed to a convection on its warm side and/or on its cold side. To improve convection, the Peltier element may be provided with cooling fins (cooling bodies) or the like. Preferably, said convection is free convection. Alternatively, said convection can also be forced convection, for which, for example, at least one blowing unit, as, in particular, a fan may be included. Depending on the situation, such a blowing unit may be switched on. In respect to the cooling operation, preferably the warm side of the Peltier element is exposed to said convection. The objective that the cold side of the Peltier element may become even colder may be achieved by means of a combination with heat sinks and, in particular, with a blowing unit on the warm side.

According to a preferred embodiment, provisions are made that the Peltier element is arranged on a housing of the battery. A housing refers to any unit device, which at least partially surrounds or encloses at least one battery. This can be, for example, a holder for the battery. Regarding the cooling operation, the cold side of the Peltier element is preferably thermally connected to the housing or extends through an opening into the interior of the housing. Thereby, the cold side of the Peltier element may be used for cooling the battery. Attaching the Peltier element can be achieved, for example, by means of adhesion, riveting, bolting, or the like.

According to a preferred embodiment, provisions are made that the Peltier element is arranged on a heat conducting plate. Such a heat conducting plate is in thermal connection with a battery, which is to be cooled and/or heated, and said heat conducting plate is preferably used to supply heat to the battery or to conduct heat away. Preferably, a heat conducting plate comprises a metal and can therefore, also be referred to as a heat conducting sheet. Regarding the cooling operation, preferably, the cold side of the Peltier element is in thermal connection with the heat conducting plate. Attachment of the Peltier element to the heat conducting plate can be achieved, for example, by means of adhesion, riveting, bolting, or the like. A plurality of Peltier elements may also be arranged on a heat conducting plate.

According to a preferred embodiment, provisions are made so that the battery includes a plurality of cells, wherein a heat conducting plate is arranged between at least two of said cells, which plate is exposed at least on one side to the outside. This allows that the heat can easily be conducted away from the inside of a battery to the outside. Conversely, heat can also be very easily supplied to the inside of the battery, if necessary. For supplying heat, a heating foil can alternatively and/or additionally be provided between individual cells. A heating foil may also be provided on at least one outer surface of the battery.

According to a preferred embodiment, provisions are made so that at least one heat conducting plate is included, which is in thermal connection with a housing (of the battery), wherein at least one Peltier element is arranged on said housing.

According to a preferred embodiment, a control unit is included, which allows to control and/or adjust the temperature of the battery by means of the Peltier element. In addition, the optional blowing unit for forcing convection can also be controlled by means of this control unit. The control unit, preferably, allows an anticipating control of the temperature of the battery. The anticipating control is based on a prediction of future system behavior. Ideally, control occurs by means of rewritable instructions, which regulate the conditioning of the battery system according to the needs of the modus of operation and/or of any potential degree of ageing. The control is preferably software-based. Preferably, the control unit may also control and/or adjust the charging status of the battery. In particular, switching the polarity of the Peltier element may also be controlled and/or adjusted by means of the control unit.

According to a preferred embodiment, provisions are made so that the control unit is arranged on the housing. Preferably, the control unit is integrated into the housing and is therefore, also, advantageously, exposed to the cooling and/or the warming of the Peltier element.

The battery system according to the invention is particularly intended for the use as an energy storage device in a motor vehicle.

The battery system according to the invention is particularly intended for the use as a stationary battery system.

Additional advantages, features, and applications of the present invention are provided by the following description in conjunction with the figures. Therein, the following is shown.

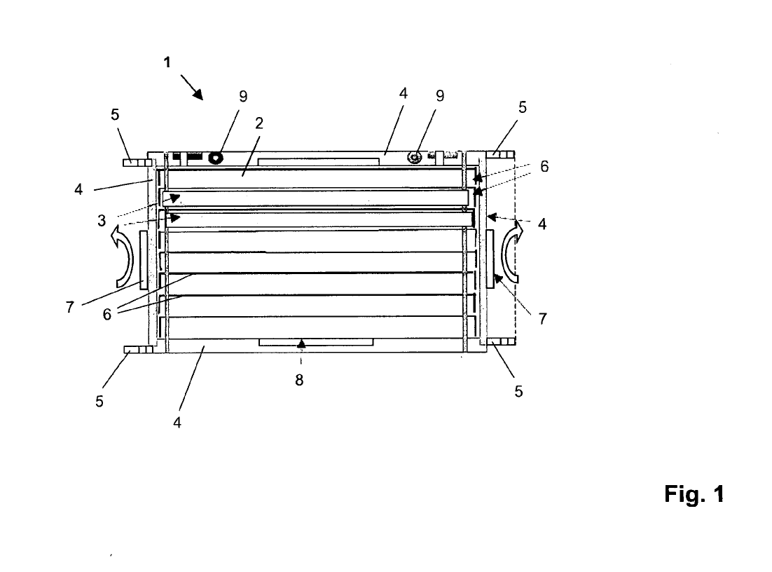

FIG. 1 shows a first embodiment in a schematic view, and

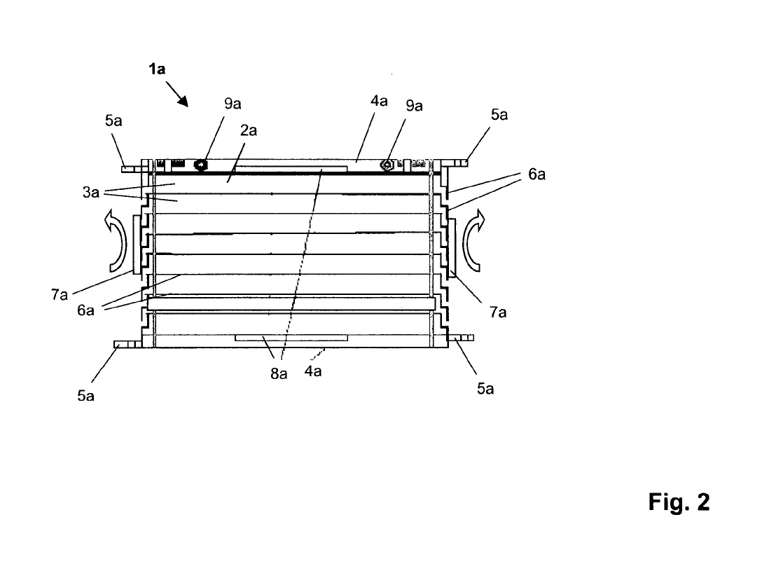

FIG. 2 shows a second embodiment in a schematic view.

FIG. 1 shows a first embodiment of a lithium-ion battery system, which is referenced to as 1. Said lithium-ion battery system 1 includes a lithium-ion battery 2, which is composed of a cell stack with a plurality of stacked cells 3. Cells 3 are electrically contacted in a way that is not limited or specified in any specific manner.

Lithium-ion battery 2 is arranged on a housing 4, which, in FIG. 1, only as an example, completely encloses lithium-ion battery 2. Housing 4 may, for example, be assembled with profiled rectangular rods. Housing 4 is provided with fixing means 5. According to FIG. 1, fixing means 5 are arranged between the right and the left side of the housing and are adjustable in height to allow that several housings may be bolted together in case of building up a group of batteries. In addition, electrical wires 9 are arranged in housing 4.

A heat conducting plate 6 is arranged between individual cells 3 as well as to terminate the cell stack in each case, wherein, according to FIG. 1, said plates protrude in each case on the right and on the left side of the cell stack. Said plates are used to conduct away heat from the inside of the cell stack to the outside, to cool the lithium-ion battery 2 or to introduce heat into the inside, i.e. said plates are also able to heat the lithium-ion battery 2, if applicable. Heat conducting plates 6 are angled on the outside and, according to FIG. 1, they are thermally connected to the right and to the left housing wall of housing 4. Heat conducting plates 6 are also used for mechanical fixing of cells 3.

In each case, a Peltier element 7 is arranged on the right and left housing wall of housing 4. The functionality of such a Peltier element 7 is outlined in detail above. Peltier elements 7 are arranged such that, with respect to the cooling operation, their cold side is in thermal connection with the housing 4. By means of a thermal connection between the housing 4 and the heat conducting plates 6, cooling can be provided for the inside of the lithium-ion battery 2, or, respectively, the heat can be conducted away from the inside of the lithium-ion battery 2 via the Peltier element 7. Likewise, any different number of Peltier elements 7 may also be provided.

Peltier elements 7 are exposed to convection on their warm sides, which are, according to FIG. 1, the sides that point away from housing 4. By means of this convection, heat is transferred to a passing air flow. The air flow is indicated by flow arrows. To improve convection, the warm sides of the Peltier elements 7 may be provided with heat fins/tabs (heating bodies). In addition, a blowing unit as, in particular, a fan may be selectively included to enhance the heat-dissipating air flow.

By switching electrical polarity, Peltier elements 7 may also be used to heat the lithium-ion battery 2. In this case, the cold side of a Peltier element 7, as defined above, becomes the warm side and the warm side becomes the cold side. The heat is introduced into the inside of the lithium-ion battery 2 by means of heat conducting plates 6. A temperature control of lithium-ion battery 2 along the circumference may be achieved by selectively switching polarity.

The lithium-ion battery system 1, according to the invention, further comprises a control unit 8, which controls and/or adjusts the temperature of the lithium-ion battery 2 by means of the Peltier elements 7. In the illustrated embodiment, control unit 8 is integrated into housing 4, or, respectively, is arranged within a designated assembly area of housing 4. Hence, the control unit is also advantageously exposed to the temperature control by the Peltier elements 7. According to FIG. 1, control unit 8 can selectively also be arranged within an assembly area, which is provided in the upper part of the housing.

According to an embodiment not shown, the Peltier elements 7 are arranged such, that their cold sides protrude through openings in the housing into the interior, which is formed by housing 4. Thereby, cooling and/or heating of said interior and hence, a temperature control of the lithium-ion battery 2 depending on the situation, may be achieved. The cold sides may be in thermal connection with heat conducting plates in the interior of the housing.

FIG. 2 shows a second embodiment of a lithium-ion battery system, which is referenced to as 1a. Here, the same components are referenced using the same reference numerals as in FIG. 1, but additionally with the suffix “a”.

The essential difference to the first embodiment according to FIG. 1 is based on the design of the heat conducting plates 6a. In FIG. 2 they are configured in their outer region as profiled frame sections, to allow an easy stacking of the cells 3a. For this, these frame sections can basically be stacked into each other, whereat the heat conducting plates 6a are also used for mechanical fixing of the cells 3a. The frame sections replace the lateral housing parts. The lateral outer surfaces of a cell stack can selectively be provided with an aluminum film or, for example, also be covered with shrink film to improve the stability.

In contrast to the first embodiment, in the second embodiment Peltier elements 7a are arranged directly onto the outer side surfaces of the cell stack or, respectively, onto the frame sections of the heat conducting plates 6a, such that they cover several heat conducting plates 6a. Preferably, provisions are made that for each heat conducting plate 6a at least one thermally connected Peltier element 7a is provided and arranged thereon. Thereby, compared to the first embodiment, the efficiency factor of the thermal coupling may be improved.

1. Battery system (1), comprising: at least one battery (2), characterized in that it further comprises at least one Peltier element (7), which is used for cooling and/or for heating at least one battery (2).

2. Battery system (1) according to claim 1, characterized in that the Peltier element (7) is used selectively for cooling and/or for heating the battery (2) by means of switching polarity.

3. Battery system (1) according to claim 1 or 2, characterized in that the Peltier element (7) is exposed to convection.

4. Battery system (1) according to any one of the preceding claims, characterized in that the Peltier element (7) is arranged on a housing (4) of the battery (2).

5. Battery system (1) according to any one of the preceding claims, characterized in that the Peltier element (7) is arranged on a heat conducting plate (6).

6. Battery system (1) according to claim 5, characterized in that the battery (2) is formed by a plurality of cells (3), wherein a heat conducting plate (6) is arranged between at least two cells (3), which plate is guided to the outside on at least one side.

7. Battery system (1) according to claim 6, characterized in that at least two heat conducting plates (6) are included, which are also used for mechanical fixing of the cells (3).

8. Battery system (1) according to any one of the preceding claims, characterized in that at least one heat conducting plate (6) is included, which is in thermal contact with a housing (4), wherein at least one Peltier element (7) is arranged on said housing (4).

9. Battery system (1) according to any one of the preceding claims, characterized in that a control unit (8) is included, which allows the control of the temperature of the battery (2) by means of the Peltier element (7).

10. Battery system according to claim 9, characterized in that control unit (8) is arranged on housing (4).

11. Use of a battery system (1) according to any one of the preceding claims for energy storage in a motor vehicle.

12. Use of a battery system according to any one of the preceding claims as a stationary battery system.
